(19) United States
(12) Patent Application Publication
(10) Pub. No.: US 2025/0245459 A1
(43) Pub. Date: Jul. 31, 2025

(54) IMAGE FORMING APPARATUS, IMAGE FORMING METHOD, AND NON-TRANSITORY RECORDING MEDIUM

(71) Applicant: Tatsuo OHYAMA, KANAGAWA (JP)

(72) Inventor: Tatsuo OHYAMA, KANAGAWA (JP)

(21) Appl. No.: 19/023,390

(22) Filed: Jan. 16, 2025

(30) Foreign Application Priority Data
Jan. 31, 2024 (JP) 2024-013406

(51) Int. Cl. G06K 15/02; H04N 1/00

(52) U.S. Cl. CPC G06K 15/027; G06K 15/1848; H04N 1/00824; G06K 2215/0094

(57) ABSTRACT

An image forming apparatus includes circuitry to generate image forming data in which a pattern that includes a first image formed with a first color and a second image formed with a second color different from the first color is arranged, the first image being arranged at a position that simultaneously satisfies a first main scanning position and a first sub-scanning position, the second image being arranged at a position that simultaneously satisfies a second main scanning position and the first sub-scanning position, the second main scanning position being different from the first main scanning position, a print engine to form a color image on a medium based on the image forming data, the color image having a plurality of images superimposed one above the other, and a reading device to read the color image formed on the medium. The circuitry is further to detect positional deviation information indicating a deviation of at least one of the first image or the second image based on the color image read by the reading device.

### CROSS-REFERENCE TO RELATED APPLICATIONS

This patent application is based on and claims priority pursuant to 35 U.S.C. § 119(a) to Japanese Patent Application No. 2024-013406, filed on Jan. 31, 2024, in the Japan Patent Office, the entire disclosure of which is hereby incorporated by reference herein.

### BACKGROUND

### Technical Field

Embodiments of the present disclosure relate to an image forming apparatus, an image forming method, and a non-transitory recording medium.

### Related Art

In the field of commercial printing (production printing), there is a demand for determining whether there is an abnormality in the print output of a printer. To meet such a demand, a technique is known in the art to read a print output of a printer with a camera or a line sensor of a scanner and use the reading result to determine whether the printing is performed under normal operating conditions.

For example, an apparatus is disclosed that includes a control unit that forms a registration patch outside an area on a recording medium where an image is formed based on a job, and a correction unit that corrects a position of the registration patch based on a read image that includes the image and the registration patch. The registration patch includes a reference color patch formed with a color material of a reference color and at least one of color patches subjected to measuring formed with color materials of colors subjected to measuring.

### SUMMARY

In one aspect, an image forming apparatus includes circuitry to generate image forming data in which a pattern that includes a first image formed with a first color and a second image formed with a second color different from the first color is arranged, the first image being arranged at a position that simultaneously satisfies a first main scanning position and a first sub-scanning position, the second image being arranged at a position that simultaneously satisfies a second main scanning position and the first sub-scanning position, the second main scanning position being different from the first main scanning position, a print engine to form a color image on a medium based on the image forming data, the color image having a plurality of images superimposed one above the other, and a reading device to read the color image formed on the medium. The circuitry is further to detect positional deviation information indicating a deviation of at least one of the first image or the second image based on the color image read by the reading device.

In another aspect, an image forming method includes generating image forming data in which a pattern that includes a first image formed with a first color and a second image formed with a second color different from the first color is arranged, the first image being arranged at a position that simultaneously satisfies a first main scanning position and a first sub-scanning position, the second image being arranged at a position that simultaneously satisfies a second main scanning position and the first sub-scanning position, the second main scanning position being different from the first main scanning position, forming a color image on a medium based on the image forming data, the color image having a plurality of images superimposed one above the other, reading the color image formed on the medium with a reading device, and detecting positional deviation information indicating a deviation of at least one of the image or the another image based on the color image read by the reading device.

In another aspect, a non-transitory recording medium stores a plurality of program codes which, when executed by one or more processors, causes the one or more processors to perform a method including generating image forming data in which a pattern that includes a first image formed with a first color and a second image formed with a second color different from the first color is arranged, the first image being arranged at a position that simultaneously satisfies a first main scanning position and a first sub-scanning position, the second image being arranged at a position that simultaneously satisfies a second main scanning position and the first sub-scanning position, the second main scanning position being different from the first main scanning position, forming a color image on a medium based on the image forming data, the color image having a plurality of images superimposed one above the other, reading the color image formed on the medium with a reading device, and detecting positional deviation information indicating a deviation of at least one of the image or the another image based on the color image read by the reading device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an image forming apparatus according to a first embodiment;

FIG. 2 is a block diagram illustrating a hardware configuration of a printer according to the first embodiment;

FIG. 3 is a block diagram illustrating a functional configuration of a printer according to the first embodiment;

FIG. 4 is a diagram illustrating a format of an inspection chart according to the first embodiment;

FIGS. 5A and 5B are diagrams each illustrating print data of an inspection chart arranged on the left or the right on a sheet;

FIGS. 6A and 6B are diagrams each illustrating read data of the inspection chart of FIGS. 5A and 5B;

FIGS. 7A and 7B are diagrams each illustrating the size and position of a pattern arranged in print data of an inspection chart according to the first embodiment;

FIG. 8 is a diagram illustrating a position of a pattern on a sheet when the pattern arranged in print data is printed on the sheet according to the first embodiment;

FIG. 9 is a block diagram illustrating a functional configuration of a chart generation unit according to the first embodiment;

FIG. 10 is a diagram illustrating a chart setting screen according to the first embodiment;

FIG. 11 is a diagram illustrating a screen in which a pattern setting area is displayed, according to the first embodiment;

FIG. 12 is a diagram illustrating a screen in which a sheet setting area is displayed, according to the first embodiment;

FIG. 13 is a block diagram illustrating a functional configuration of an inspection apparatus according to the first embodiment;

FIG. 14 is a diagram illustrating a pattern in read data according to the first embodiment;

FIGS. 15A and 15B are diagrams each illustrating a screen in which a display setting area is displayed, according to the first embodiment;

FIG. 16 is a flowchart of a positional deviation detection process according to the first embodiment;

FIG. 17 is a diagram illustrating a detection result generated through a detection process according to the first embodiment;

FIGS. 18A to 18C are diagrams each illustrating a table of a detection result displayed in another manner according to the first embodiment;

FIG. 19 is a flowchart of the process to obtain a statistical value of positional deviation information through a detection process, according to the first embodiment;

FIG. 20 is a diagram illustrating a statistical value of positional deviation information of each pattern generated through a detection process, according to the first embodiment;

FIG. 21 is a diagram illustrating a pattern of an inspection chart in print data and read data, according to the first embodiment;

FIG. 22 is a block diagram illustrating a functional configuration of an inspection apparatus according to a second embodiment;

FIG. 23 is a diagram illustrating the coordinates of a pattern in print data and the coordinates of an image of each color in read data, according to the second embodiment;

FIGS. 24A and 24B are diagrams each illustrating a display setting area according to the second embodiment;

FIG. 25 is a diagram illustrating a detection result generated through a detection process according to the second embodiment; and

FIGS. 26A to 26C are diagrams each illustrating a table of a detection result displayed in another manner, according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An image forming apparatus, an image forming method, and a non-transitory recording medium according to embodiments of the present disclosure are described in detail below with reference to the accompanying drawings.

### First Embodiment

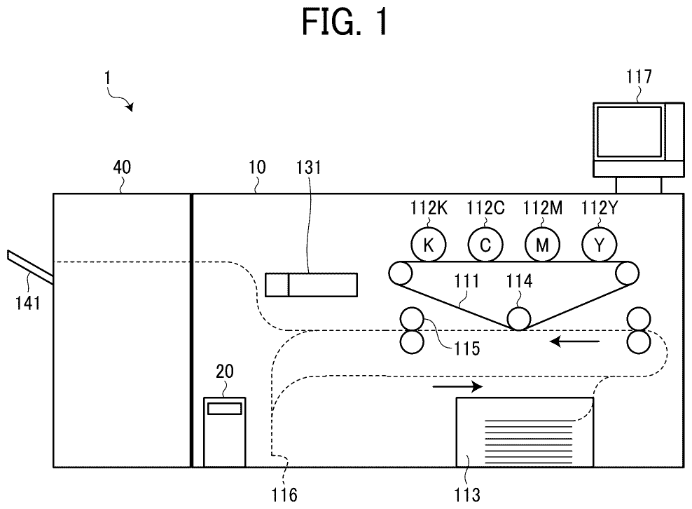

FIG. 1 is a diagram illustrating a configuration of an image forming apparatus 1 according to a first embodiment.

The image forming apparatus 1 includes a printer 10 including an inspection apparatus 20, and a stacker 40. These components are communicably connected to each other via, for example, a communication line or a communication network. While the inspection apparatus 20 may be provided in the printer 10 as illustrated in FIG. 1, the inspection apparatus 20 may be separate from the printer 10.

The printer 10 receives print job data including a user image from an external device such as a digital front end (DFE) apparatus. The printer 10 executes printing in response to an execution instruction included in the received print job data or an operation performed by an operator on, for example, an operation panel 117 provided for the printer 10. The print job data includes image data, and job information indicating attributes of the image data such as the number of copies to be printed, the number of pages, information indicating whether double-sided printing or single-sided printing is to be performed, and the type of sheet.

The printer 10 has a configuration in which photoconductor drums 112Y, 112M, 112C, and 112K corresponding to yellow (Y), magenta (M), cyan (C), and black (K), respectively, are disposed along a conveyance belt 111 that is an endless conveyer.

Specifically, the printer 10 includes the photoconductor drums 112Y, 112M, 112C, and 112K arranged in this order from upstream in the conveyance direction of the conveyance belt 111. The conveyance belt 111 is an intermediate transfer belt on which an intermediate transfer image is formed. The intermediate transfer image is to be transferred onto a sheet fed from a sheet feeding tray 113 along the conveyance belt 111. In the present embodiment, the sheet is an example of a medium on which a color image is formed.

The printer 10 transfers K, C, M, and Y toner images, which are developed with the toner on the surfaces of the respective photoconductor drums, onto the conveyance belt 111 in a superimposed manner to form a full-color image. In the present embodiment, these colors are examples of a plurality of colors including a first color and a second color, and the toner images of these colors are examples of multiple images that are superimposed one on another on a medium to form a color image.

The printer 10 transfers the full-color image formed on the conveyance belt 111 onto the surface of the sheet conveyed on the conveyance path by a transfer roller 114 at a position closest to the conveyance path of the sheet indicated by a broken line in FIG. 1.

The printer 10 further conveys the sheet on which the image is formed, fixes the image with a fixing roller pair 115, and conveys the sheet to a reading device 131. The reading device 131 reads the sheet conveyed via the fixing roller pair 115, generates read image data that includes a read image, and inputs the read image data to the inspection apparatus 20. The read image is, for example, an image with 200 dots per inch (dpi) formed in 8 bits in a red, green, and blue (RGB) format. The width of one pixel is approximately 0.127 mm. The reading device 131, which is an imaging sensor, may acquire an image after the toner is fixed with the fixing roller pair 115, or may acquire an image before entering the fixing roller pair 115 after being transferred by the transfer roller 114. Accordingly, the reading device 131 may be disposed at a location other than the location in FIG. 1.

In the case of single-sided printing, the printer 10 ejects the sheet after being read by the reading device 131 to the stacker 40 without any other operation. In the case of double-sided printing, the printer 10 reverses the sheet after being read by the reading device 131 using a reverse path 116 and conveys the sheet again to the position where the toner image has been transferred by the transfer roller 114.

The printer 10 transfers and fixes another toner image onto the other side of the sheet having the image on the side. The reading device 131 reads the other side of the sheet on which another image is formed. The printer 10 ejects the sheet having the images on both sides to the stacker 40.

The stacker 40 stacks the sheets ejected from the printer 10 on a tray 141.

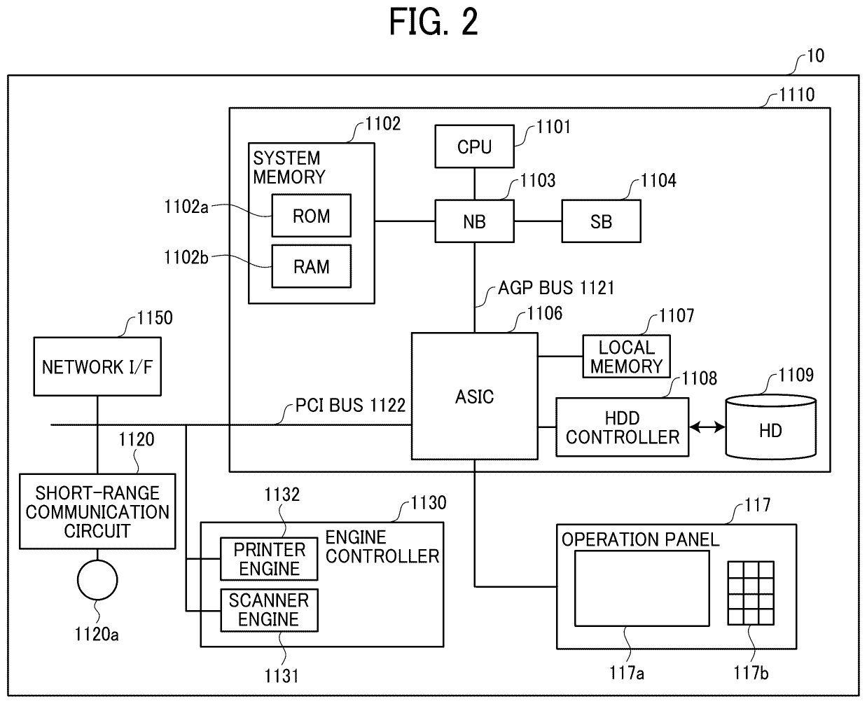

The inspection apparatus 20 inspects the read image read by the reading device 131 through a process described later to detect positional deviation (positional deviation information) that occurs at the time of printing. The operation panel 117 acquires information indicating the inspection result from the inspection apparatus 20 and displays the information. FIG. 2 is a block diagram illustrating a hardware configuration of the printer 10 according to the first embodiment.

The printer 10 includes a controller 1110, a short-range communication circuit 1120, an engine controller 1130, the operation panel 117, and a network interface (I/F) 1150.

The controller 1110 includes a central processing unit (CPU) 1101 as a main processor, a system memory 1102, a north bridge (NB) 1103, a south bridge (SB) 1104, an application-specific integrated circuit (ASIC) 1106, a local memory 1107 as a storage area, a hard disk drive (HDD) controller 1108, and a hard disk (HD) 1109 as the storage area. In alternative to the local memory 1107 or the HD 1109, a solid-state drive (SSD) may be used as the storage area.

The NB 1103 and the ASIC 1106 are connected to each other through an accelerated graphics port (AGP) bus 1121.

The CPU 1101 is a processor that controls the entire operation of the image forming apparatus 1 including the printer 10. The NB 1103 is a bridge for connecting the CPU 1101 with the system memory 1102, the SB 1104, and the AGP bus 1121. The NB 1103 includes a memory controller for controlling the reading and writing of various data from and to the system memory 1102, a peripheral component interconnect (PCI) master, and an AGP target.

The system memory 1102 includes a read-only memory (ROM) 1102a as a memory that stores programs and data for implementing various functions of the controller 1110. The system memory 1102 further includes a random-access memory (RAM) 1102b used as a memory to load the programs and the data, or as a drawing memory that stores drawing data for printing. For the distribution, the programs stored in the ROM 1102a may be stored in any computer-readable recording medium, such as a compact disc-read only memory (CD-ROM), a compact disc-recordable (CD-R), or a digital versatile disc (DVD), in a file format installable or executable by a computer.

The SB 1104 is a bridge for connecting the NB 1103 to PCI devices and peripheral devices. The ASIC 1106 is an integrated circuit (IC) dedicated to image processing and includes hardware elements for image processing. The ASIC 1106 serves as a bridge to connect the AGP bus 1121, a PCI bus 1122, the HDD controller 1108, and the local memory 1107 to one another.

The ASIC 1106 includes a PCI target, an AGP master, an arbiter (ARB) as a central processor of the ASIC 1106, a memory controller to control the local memory 1107, a plurality of direct memory access controllers (DMACs), and a PCI unit. For example, the DMACs convert coordinates of image data with hardware logic to rotate an image based on the image data. The PCI unit transfers data between a scanner engine 1131 and a printer engine 1132. To the ASIC 1106, a universal serial bus (USB) interface or the Institute of Electrical and Electronics Engineers 1394 (IEEE 1394) interface may be connected.

The local memory 1107 is a memory used as a buffer for image data to be copied or a code buffer. The HD 1109 is a storage device that stores image data, font data for printing, and form data. The HDD controller 1108 controls the reading and writing of data from and to the HD 1109 under the control of the CPU 1101.

The AGP bus 1121 is a bus interface for a graphics accelerator card, which has been proposed to accelerate graphics processing. The AGP bus 1121 directly accesses the system memory 1102 with high throughput to accelerate the graphics accelerator card.

The short-range communication circuit 1120 is provided with a short-range communication antenna 1120a. The short-range communication circuit 1120 is a communication circuit in compliance with, for example, the near field communication (NFC) or BLUETOOTH.

The engine controller 1130 includes the scanner engine 1131 and the printer engine 1132. The operation panel 117 includes a panel display 117a and an operation keypad 117b. The panel display 117a is, for example, a touch panel that displays current settings or a selection screen, and receives input from the operator. The operation keypad 117b includes, for example, a numeric keypad and a start key. The numeric keypad receives assigned values of image forming parameters such as an image density parameter. The start key receives an instruction to start copying. The panel display 117a is an example of a display (display device). The panel display 117a receives touch input from the operator. The operator can perform operations such as inputting a numerical value into an input box displayed on a screen, selecting a pull-down menu, and turning on or off a check box using, for example, a finger or a pen. The operation keypad 117b may include an input device such as a trackball or a touch pad in addition to the numeric keypad.

The controller 1110 controls the entire operation of the image forming apparatus including the printer 10. For example, the controller 1110 controls drawing, communication, input through the operation panel 117, reading of a print result performed by the reading device 131, and inspection of read data performed by the inspection apparatus 20. The scanner engine 1131 reads an image formed on a medium being conveyed such as a sheet of paper to generate image data. The printer engine 1132 includes a transfer device, a fixing device, and a heating device or a drying device, and forms an image on a sheet of paper. The transfer device transfers an image formed with a color material, such as a toner image, onto the medium being conveyed, such as the sheet. The fixing device fixes the image to the sheet. The scanner engine 1131 or the printer engine 1132 executes image processing such as error diffusion and gamma conversion.

The sheet is an example of a medium being conveyed. The medium being conveyed is not limited to the sheet of paper. As long as the medium can be placed on the sheet feeding tray included in the printer 10, and is conveyed and output in response to an instruction to output the medium, the medium to be conveyed may be a sheet of film or a sheet of plastic.

The network I/F 1150, which may be implemented by an interface circuit, is an interface that controls the communication of data through the communication network. The short-range communication circuit 1120 and the network I/F 1150 are electrically connected to the ASIC 1106 via the PCI bus 1122.

In FIG. 2, the printer 10 has an image forming mechanism that forms an image using an electrophotographic method. Alternatively, the printer 10 may have another image forming mechanism that forms an image using, for example, an inkjet printing system.

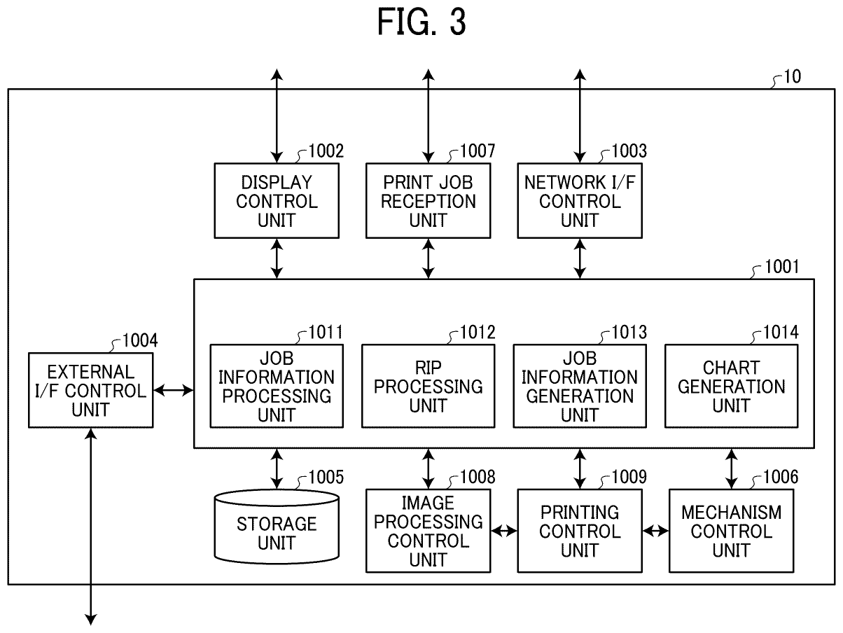

FIG. 3 is a block diagram illustrating a functional configuration of the printer 10 according to the first embodiment. The printer 10 includes a system control unit 1001, a display control unit 1002, a network I/F control unit 1003, an external I/F control unit 1004, a storage unit 1005, a mechanism control unit 1006, a print job reception unit 1007, an image processing control unit 1008, and a printing control unit 1009. These functional units are implemented by the CPU 1101 or the ASIC 1106 executing processing defined in one or more programs stored in, for example, the system memory 1102 or the local memory 1107.

The system control unit 1001 controls the entire operation of the printer 10. The system control unit 1001 includes a job information processing unit 1011, a raster image processor (RIP) processing unit 1012, a job information generation unit 1013, and a chart generation unit 1014.

The job information processing unit 1011 processes job information included in print job data transmitted from, for example, the DFE apparatus. The RIP processing unit 1012 processes RIP image data included in print job data transmitted from, for example, the DFE apparatus. The RIP image is, for example, an image with 600 dpi formed in 8 bits in a cyan, magenta, yellow, and black (CMYK) format, and is an example of print data (image formation data).

In response to receiving information instructing insertion of a sheet for inspection from the inspection apparatus 20, the job information generation unit 1013 generates job information for inserting the sheet.

The chart generation unit 1014 generates print data in which an inspection chart, which will be described later, is arranged. In the present embodiment, the chart generation unit 1014 is an example of an image arrangement unit, and the print data in which the inspection chart is arranged is an example of the image formation data.

The display control unit 1002 controls the display of various information including job information on the operation panel 117. The network I/F control unit 1003 controls the operation of the network I/F 1150 to control the connection to the communication network. When an external device is connected, the external I/F control unit 1004 controls the connection with the external device. The storage unit 1005 stores various information including job information.

The mechanism control unit 1006 controls the operation of the mechanism of the printer 10, such as the sheet conveyance and the transfer process performed by the printer 10 including the printer engine 1132. The print job reception unit 1007 receives print job data from, for example, the DFE apparatus. The image processing control unit 1008 processes the print image transferred by the mechanism control unit 1006. The printing control unit 1009 controls the image formation on a medium being conveyed. The mechanism control unit 1006, the image processing control unit 1008, and the printing control unit 1009 operate in cooperation with each other to function as an image forming unit that forms an image on a medium being conveyed.

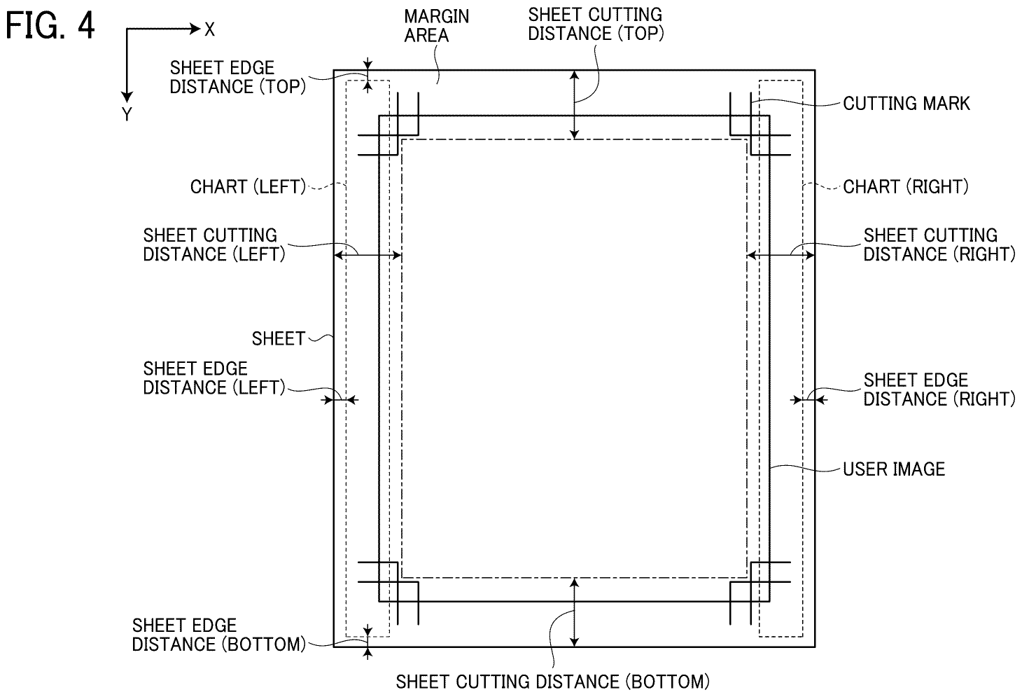

FIG. 4 is a diagram illustrating a format of the inspection chart according the first embodiment. The inspection chart is printed (formed) by the image forming apparatus 1, and read by the reading device 131 to generate read data. The read data is used for inspection performed by the inspection apparatus 20. In FIG. 4, an X-axis represents the main scanning direction, and a Y-axis represents the sub-scanning direction.

As illustrated in FIG. 4, the inspection chart is formed in the areas indicated by the broken lines on the left and the right of a sheet (medium). The inspection chart on the left is defined by a sheet edge distance (left), a sheet edge distance (top), and a sheet edge distance (bottom), which are the distances from the respective edges of the sheet, and the size of an individual image included in a pattern and a pattern interval, which will be described later. Similarly, the inspection chart on the right is defined by a sheet edge distance (right), the sheet edge distance (top), and the sheet edge distance (bottom), which are the distances from the respective edges of the sheet, and the size of an individual image included in a pattern and a pattern interval, which will be described later.

On the sheet, in addition to the inspection chart, a user image and cutting marks are printed. In the following description, any one of the cutting marks is referred to as a cutting mark unless particularly distinguished from each other. An area on the sheet excluding the area of the user image is referred to as a margin area. The positions of the cutting marks are defined by a sheet cutting distance (left), a sheet cutting distance (right), a sheet cutting distance (top), and a sheet cutting distance (bottom) as illustrated in FIG. 4. Since the area outside of the area surrounded by the one-dot chain line is removed by cutting, the inspection chart is arranged outside the area surrounded by the one-dot chain line.

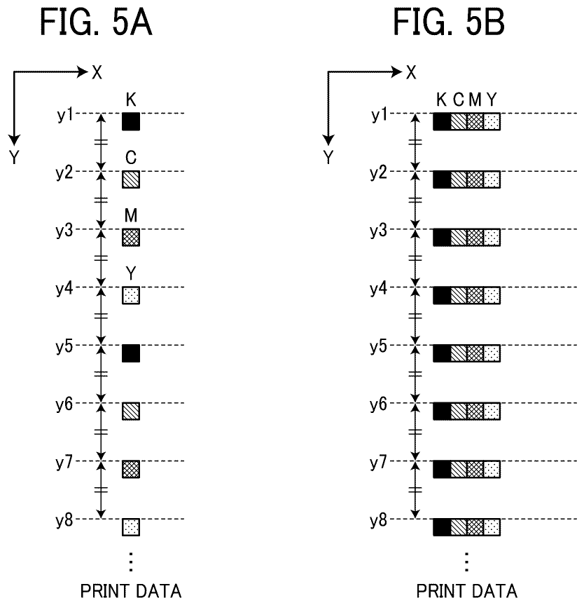

FIGS. 5A and 5B are diagrams each illustrating print data of the inspection chart arranged on the left or the right on the sheet. In FIG. 5A, an example of a conventional inspection chart is illustrated. In the conventional inspection chart, a pattern formed of a single color is arranged in the X-axis direction, and another pattern formed of a color different from the color used for the pattern positioned one above is repeatedly arranged at equal intervals in the Y-axis direction. In FIG. 5B, the inspection chart according to the present embodiment is illustrated. In the inspection chart according to the present embodiment, a pattern formed of a plurality of different colors arranged in the X-axis direction is arranged at a position of a coordinate y1 in the Y-axis direction, and the same pattern is repeatedly arranged at equal intervals in the Y-axis direction.

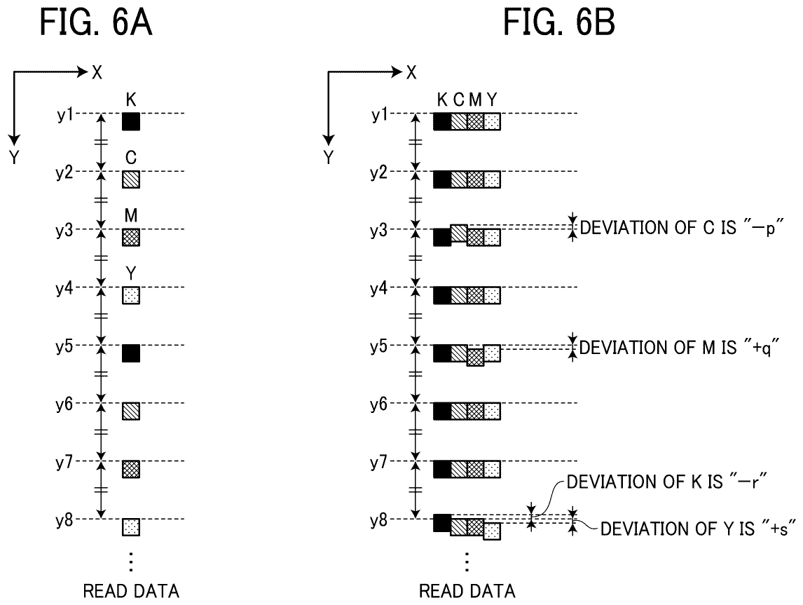

An image representing the print data of the inspection chart described above is printed on a sheet, and the reading device 131 reads the image to generate read data. FIGS. 6A and 6B are diagrams each illustrating the read data of the inspection chart. In FIG. 6A, the read data corresponding to the inspection chart of FIG. 5A is illustrated. In FIG. 6B, the read data corresponding to the inspection chart of FIG. 5B is illustrated.

In FIG. 6B, a cyan (C) color is positionally deviated upward at a position of a coordinate y3 in the Y-axis direction, a magenta (M) color is positionally deviated downward at a position of a coordinate y5 in the Y-axis direction, and a black (K) color and a yellow (Y) color are positionally deviated upward and downward, respectively, at a position of a coordinate y8 in the Y-axis direction. Even when such positional deviations occur, if the inspection chart of FIG. 5A is used, there is no deviation of the pattern intervals in the Y-axis direction in the read data as illustrated in FIG. 6A. In contrary, if the inspection chart of FIG. 5B is used, there are deviations of the pattern intervals in the Y-axis direction in the read data for the colors having a positional deviation as illustrated in FIG. 6B. In the present embodiment, the positional deviation information is detected by inspecting the deviation in the Y-axis direction in the read data.

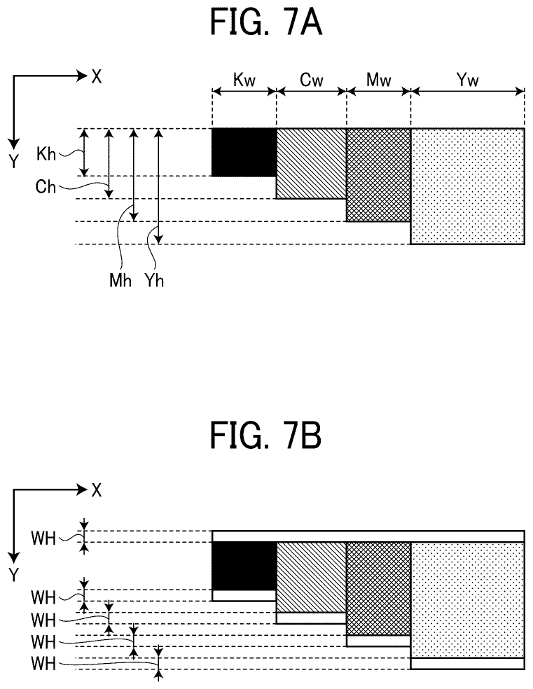

FIGS. 7A and 7B are diagrams each illustrating the size and position of the pattern arranged in the print data of the inspection chart according to the first embodiment. In FIG. 7A, Kw, Cw, Mw, and Yw are the widths of an image of K color, an image of C color, an image of M color, and an image of Y color included in the pattern, respectively. Similarly, Kh, Ch, Mh, and Yh are the heights of the image of K color, the image of C color, the image of M color, and the image of Y color included in the pattern, respectively. The upper ends of the images of the respective colors are arranged so as to coincide with each other in the Y-axis direction. In the present embodiment, the images of the respective colors are examples of a first image and a second image.

In FIG. 7B, WH is the width of a blank area added to each of the upper and lower ends of the image of each color. The blank area has a color represented by red (R), green (G), and blue (B) data having equal values. When the equal values are at the maximum, the color is white. When the equal values are at the minimum, the color is black. When the equal values are in between, the color is gray. The blank area facilitates detection of the coordinates of the upper and lower ends of the image of each color in the pattern. In particular, when a pattern is superimposed on the user image, it is preferable that blank areas are provided. When the detection of the coordinates of the lower end is not required, a blank area does not need to be added to the lower end of the image. In addition, in order to facilitate detection of the coordinates of the right end or the left end, a blank area may be added to the right end or the left end of the image of the pattern. The blank area may be arranged inside the image of the pattern.

The images of the colors in the pattern may be arranged apart from each other or may be arranged to overlap each other. In addition, the image of the colors in the pattern sometimes overlap each other due to positional deviation at the time of printing. In such a case, the widths of the non-overlapping areas of the images of the colors are smaller than the widths of the images of the colors when the colors do not overlap each other. In consideration of this, it is preferable that the number of pixels of a non-overlapping area of the image of each color is set, at the time of setting, to be n×t pixels or more for the number of pixels n required for detecting the coordinates of the image of each color. In the present embodiment, t is a correction value in consideration of the positional deviation, and is, for example, a value greater than one.

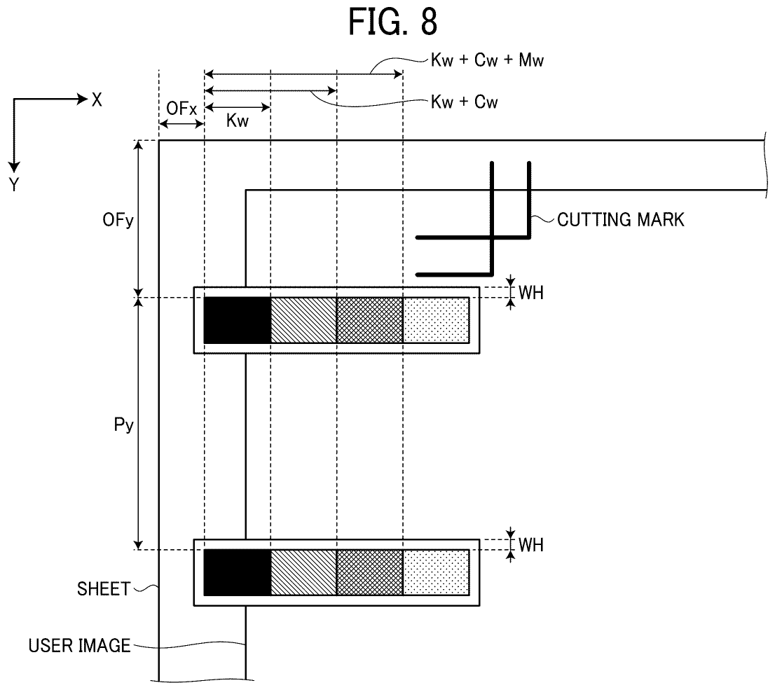

FIG. 8 is a diagram illustrating the position of the pattern on a sheet when the pattern arranged in the print data is printed on the sheet according to the first embodiment. The pattern first from the top of the inspection chart on the left is arranged at the position of the coordinates (OFx,OFy) as illustrated in FIG. 8. Note that the coordinates at the top-left corner of the sheet are assumed to be (0,0). In FIG. 8, the offset in the main scanning direction (main scanning offset) of the image of each color from the left end of the pattern is 0 (zero) for the image of K color, Kw for the image of C color, Kw+Cw for the image of M color, and Kw+Cw+Mw for the image of Y color. The offset is a value that represents the difference (a distance, a deviation, a relative position) from a reference position when a position of an object is indicated in the present embodiment. In the present embodiment, the main scanning position (OFx) of the image of K color is an example of a first main scanning position. The main scanning position of any one of the image of C color (OFx 30 KW), the image of M color (OFx+Kw+Cw), and the image of Y color (OFx+Kw+Cw+Mw) is an example of a second main scanning position.

The pattern second from the top of the inspection chart on the left is arranged at coordinates (OFx,OFy+Py) that are Py away from the pattern first from the top in the sub-scanning direction. In the present embodiment, the sub-scanning position (OFy) of the pattern first from the top is an example of a first sub-scanning position, and the sub-scanning position (OFy+Py) of the pattern second from the top is an example of a second sub-scanning position. Similarly, the patterns third or more from the top of the inspection chart on the left are arranged at coordinates Py away from the pattern one above in the sub-scanning direction at a same interval, within a region not exceeding the lower limit of the area of the inspection chart illustrated in FIG. 4. The right end of each pattern (the right end including a blank area in the case where the blank area is arranged at the right end) is arranged so as to be inside the cutting area indicated by the cutting marks. When the pattern is repeatedly arranged and overlaps a cutting mark, only the overlapping pattern may be shifted in the sub-scanning direction to avoid overlapping the cutting mark.

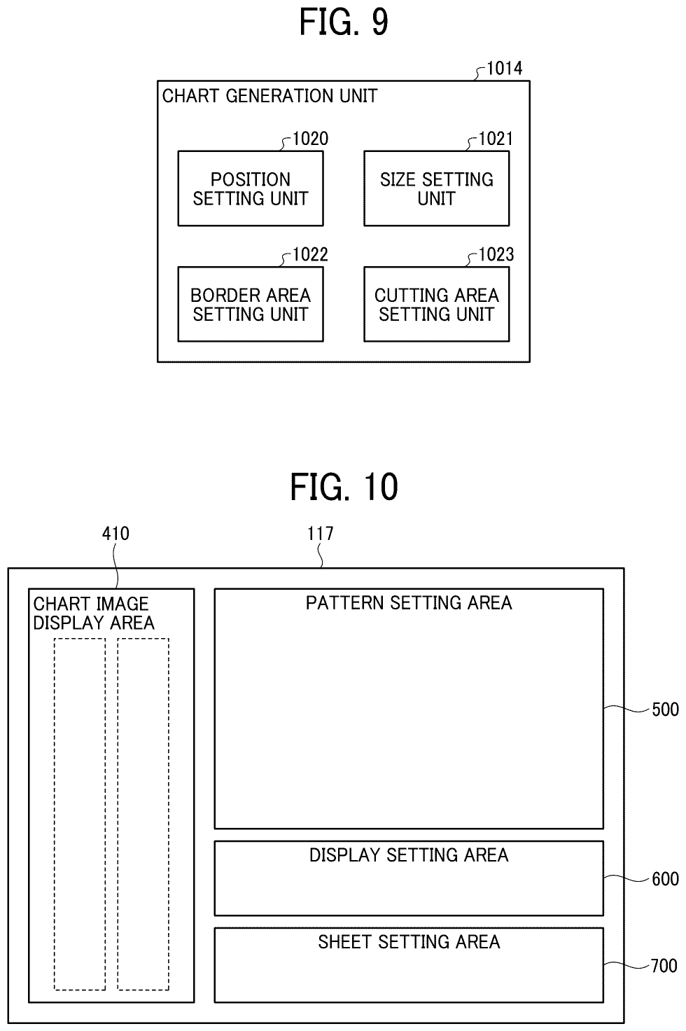

FIG. 9 is a block diagram illustrating a functional configuration of the chart generation unit 1014 according to the first embodiment. As illustrated in FIG. 9, the chart generation unit 1014 includes a position setting unit 1020, a size setting unit 1021, a border area setting unit 1022, and a cutting area setting unit 1023.

The position setting unit 1020 sets a position of a pattern included in the inspection chart and a position of the image of each color included in the pattern. The size setting unit 1021 sets the size of the image of each color. The border area setting unit 1022 sets the size and color of a blank area. The cutting area setting unit 1023 sets information on a cutting area.

FIG. 10 is a diagram illustrating a chart setting screen according to the first embodiment. The chart setting screen is displayed on the operation panel 117, and is used for setting, for example, the size and position of the image of each color of the pattern in response to receiving input from the operator. The chart setting screen includes a chart image display area 410, a pattern setting area 500, a display setting area 600, and a sheet setting area 700.

The chart image display area 410 is an area where an image of an inspection chart generated according to set values is displayed. In the area surrounded by a broken line on the left of the chart image display area 410, the image of the inspection chart to be generated on the left of the sheet is displayed. In the area surrounded by another broken line on the right of the chart image display area 410, the image of the inspection chart to be generated on the right of the sheet is displayed.

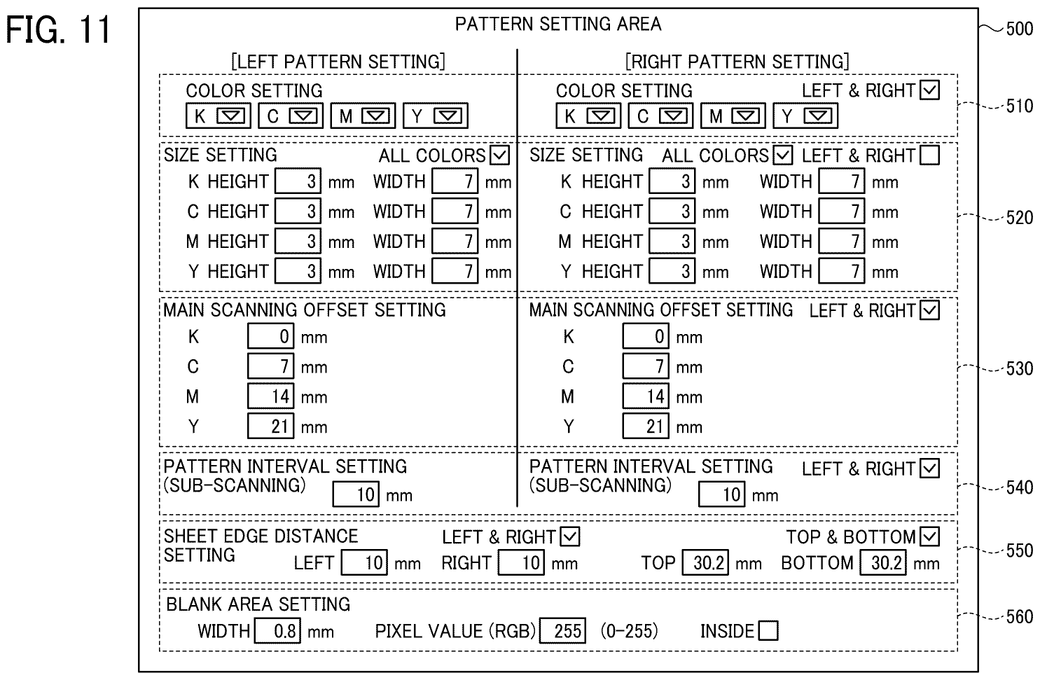

FIG. 11 is a diagram illustrating a screen in which the pattern setting area 500 is displayed, according to the first embodiment. The pattern setting area 500 includes a color setting area 510, a size setting area 520, a main scanning offset setting area 530, a pattern interval setting area 540, a sheet edge distance setting area 550, and a blank area setting area 560.

The color setting area 510 is used for setting the color of an image to be included in a pattern. The operator can set a color of each image using, for example, a pull-down menu marked with a downward triangle. In FIG. 11, the K, C, M, and Y colors are set in order from the left of the pattern for the left of the inspection chart. The operator can copy the colors set for the left of the inspection chart to the colors to be set for the right of the inspection chart by checking a check box labeled “LEFT & RIGHT” at the right end of the color setting area 510. When the check box labeled “LEFT & RIGHT” is not checked, each color of the images for the right of the inspection chart can be set using a pull-down menu for setting a color on the right of the color setting area 510. When the check box labeled “LEFT & RIGHT” is checked, the operation for setting each color of the images for the right of the inspection chart does not need to be performed. Accordingly, the pull-down menu may be grayed out so as not to be operated.

The size setting area 520 is used for the operator to input the size of the image of each color of the pattern. The size setting unit 1021 sets the size of the image of each color based on the information on the size input in the size setting area 520 and the interval (pattern interval) of each pattern in the sub-scanning direction. The name of each color set in the color setting area 510 is displayed to the left of an individual input box for the height. In FIG. 11, the name of each of K, C, M, and Y colors for the left of the inspection chart is displayed in order from the top on the left of the size setting area 520. The operator can set the size (height and width) of each color by inputting a value into an individual input box corresponding to the height or width of each color. The size of an image of one color is reflected to the images of the rest of the colors for the left or the right of the inspection chart by the operator checking a check box labeled “ALL COLORS” corresponding to the left or the right. Thus, the same size is set for the images of all the colors for the left or right of the inspection chart. When the check box labeled “ALL COLORS” is not checked, the size of an image of each color can be set individually. When the check box labeled “ALL COLORS” is checked, the operation for setting the sizes for the images of the rest of the colors other than one color does not need to be performed. Accordingly, the input boxes for setting the sizes of the images of the rest of the colors may be grayed out so as not to be operated. Further, similarly to the color setting area 510, when another check box labeled “LEFT & RIGHT” at the right end of the size setting area 520 is not checked, the sizes of the images of the colors for the right of the inspection chart can be set separately from the sizes of the images of the colors for the left of the inspection chart. When the other check box labeled “LEFT & RIGHT” is checked, the operation for setting the sizes of the images of the colors for the right of the inspection chart does not need to be performed. Accordingly, the input boxes for setting the sizes of the images of the colors for the right of the inspection chart may be grayed out so as not to be operated.

The main scanning offset setting area 530 is used for the operator to input an offset (main scanning offset) of the image of each color of the pattern in the main scanning direction. The position setting unit 1020 sets the main scanning position of the image of each color based on the information on the offset input in the main scanning offset setting area 530 and the information on the sheet edge distance to be described later. Similarly to the color setting area 510, when still another check box labeled “LEFT & RIGHT” at the right end of the main scanning offset setting area 530 is not checked, the offsets of the images of the colors for the right of the inspection chart can be set separately from the offsets of the images of the colors for the left of the inspection chart. When still the other check box labeled “LEFT & RIGHT” is checked, the input boxes for setting the offsets of the images of the colors for the right of the inspection chart may be grayed out so as not to be operated.

The pattern interval setting area 540 is used for the operator to input a pattern interval (Py in FIG. 8). Similarly to the color setting area 510, when still another check box labeled “LEFT & RIGHT” at the right end of the pattern interval setting area 540 is not checked, the pattern interval for the right of the inspection chart can be set separately from the pattern interval for the left of the inspection chart. When still the other check box labeled “LEFT & RIGHT” is checked, the input box for setting the pattern interval for the right of the inspection chart may be grayed out so as not to be operated.

The sheet edge distance setting area 550 is used for the operator to input distances (sheet edge distances) from the respective edges of the sheet to the area where the pattern is arranged. The operator can set the respective values of the “sheet edge distance (left),” “sheet edge distance (right),” “sheet edge distance (top),” and “sheet edge distance (bottom)” illustrated in FIG. 4 using the input boxes. When still another check box labeled “LEFT & RIGHT” in the middle of the sheet edge distance setting area 550 is not checked, the value for the “sheet edge distance (right)” can be set separately from the value for the “sheet edge distance (left).” When still the other check box labeled “LEFT & RIGHT” is checked, the input box for setting the value for the “sheet edge distance (right)” may be grayed out so as not to be operated. Further, when a check box labeled “TOP & BOTTOM” at the right end of the sheet edge distance setting area 550 is not checked, the value for the “sheet edge distance (bottom)” can be set separately from the value for the “sheet edge distance (top).” When the check box labeled “TOP & BOTTOM” is checked, the input box for setting the value for the “sheet edge distance (bottom)” may be grayed out so as not to be operated.

The blank area setting area 560 is used for the operator to input the width (WH in FIG. 7B and FIG. 8) and color of the blank area. The border area setting unit 1022 sets a position where the blank area is arranged and a color of the blank area based on the information on the width and color input in the blank area setting area 560. When a check box labeled “INSIDE” is not checked, the blank area is arranged outside the pattern. When the check box labeled “INSIDE” is checked, the blank area is arranged inside the pattern.

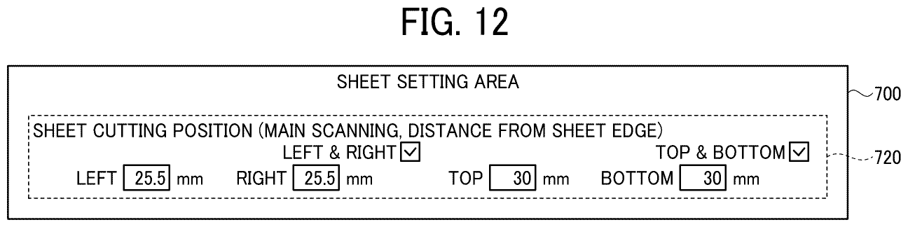

As described above, for the left of the inspection chart, the condition is set that the right end of each pattern (the right end including a blank area) is arranged so as to be inside the cutting area indicated by the cutting marks. In the case where the setting set in the pattern setting area 500 does not satisfy this condition, the display control unit 1002 prompts the operator to correct the setting by, for example, displaying a warning screen or displaying a set value in red. FIG. 12 is a diagram illustrating a screen in which the sheet setting area 700 is displayed, according to the first embodiment. The sheet setting area 700 includes a sheet cutting position setting area 720.

The sheet cutting position setting area 720 is used for the operator to input sheet cutting positions. The cutting area setting unit 1023 sets positions where cutting marks are arranged based on the information on the sheet cutting positions input in the sheet cutting position setting area 720. Check boxes labeled “LEFT & RIGHT” and “TOP & BOTTOM” have the same functions as those in the sheet edge distance setting area 550, respectively.

In the embodiment described above, a case has been described in which the operator sets the values and the like of each area in the pattern setting area 500 and the sheet setting area 700. However, some of these values and the like may be set in advance. For example, the values set in advance may be 30.2 mm for both the top and bottom of the sheet edge distances, 10 mm for both the left and right of the sheet edge distances, 10 mm for both the left and right of the pattern intervals, 25.5 mm for both the left and right of the sheet cutting positions, and 0.8 mm for the width and 255 for the pixel value of the blank area.

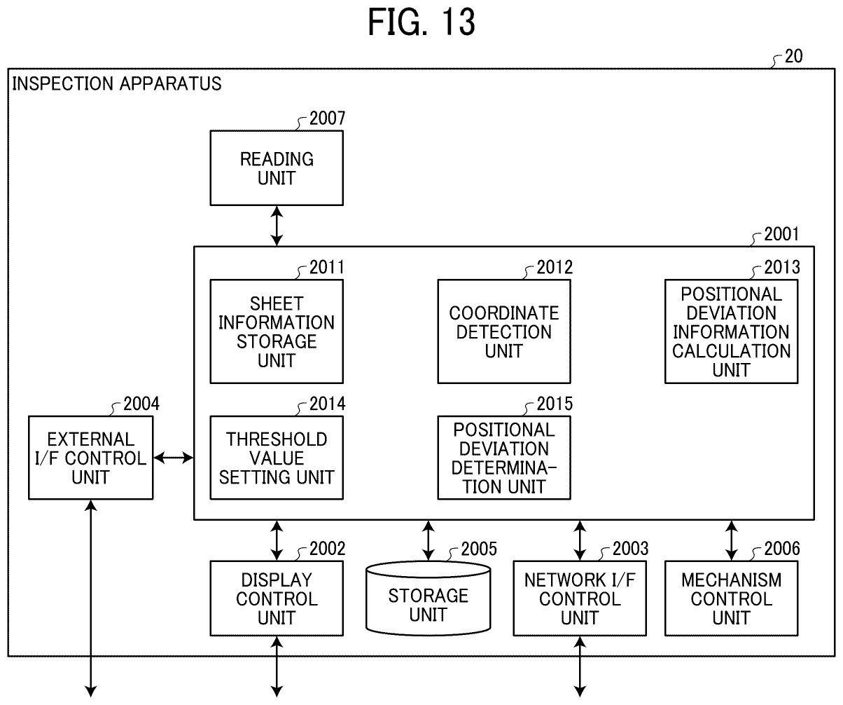

FIG. 13 is a block diagram illustrating a functional configuration of the inspection apparatus 20 according to the first embodiment. The inspection apparatus 20 includes a system control unit 2001, a display control unit 2002, a network I/F control unit 2003, an external I/F control unit 2004, a storage unit 2005, a mechanism control unit 2006, and a reading unit 2007. These functional units provide functions implemented by the CPU 1101 or the ASIC 1106 executing processing defined in one or more programs installed in, for example, the system memory 1102 or the local memory 1107.

The system control unit 2001 controls the entire operation of the inspection apparatus 20. The system control unit 2001 extracts information to be processed by a post-processing apparatus (for example, an apparatus that performs post-processing such as the stacker 40) from job information and transmits the information to be processed to the post-processing apparatus via the external I/F control unit 2004. The system control unit 2001 also transfers the job information excluding the information to be processed by the post-processing apparatus to the reading unit 2007 and the mechanism control unit 2006.

The system control unit 2001 includes a sheet information storage unit 2011, a coordinate detection unit 2012, a positional deviation information calculation unit 2013, a threshold value setting unit 2014, and a positional deviation determination unit 2015.

The sheet information storage unit 2011 stores sheet information. The sheet information is information indicating attributes such as a size of a sheet. For example, the sheet information includes coordinate values indicating an edge of the sheet obtained from print job data.

The coordinate detection unit 2012 detects, for the image of each color, the coordinates of the upper end of the image from the read data of the inspection chart input from the reading unit 2007 using, for example, pattern matching.

The positional deviation information calculation unit 2013 calculates positional deviation information for the image of each color based on the coordinates detected by the coordinate detection unit 2012.

The threshold value setting unit 2014 sets a threshold value based on a numerical value input in a threshold value setting area 620 of a display setting area 600, which will be described later.

The positional deviation determination unit 2015 determines the positional deviation based on the positional deviation information and the threshold value, and outputs the determination result to the display control unit 2002.

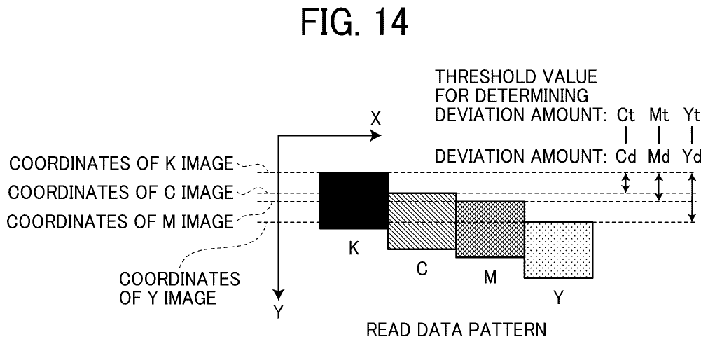

FIG. 14 is a diagram illustrating the pattern in the read data according to the first embodiment. As illustrated in FIG. 14, when the images of C, M, and Y colors are printed with deviations in the sub-scanning direction relative to the image of K color due to positional deviation at the time of printing, the deviation amounts of the images of C, M, and Y colors from the image of K color are Cd, Md, and Yd, respectively, based on the coordinates of the images of the respective colors. As the threshold values for determining the positional deviation for the deviation amounts of Cd, Md, and Yd, Ct, Mt, and Yt are set, respectively.

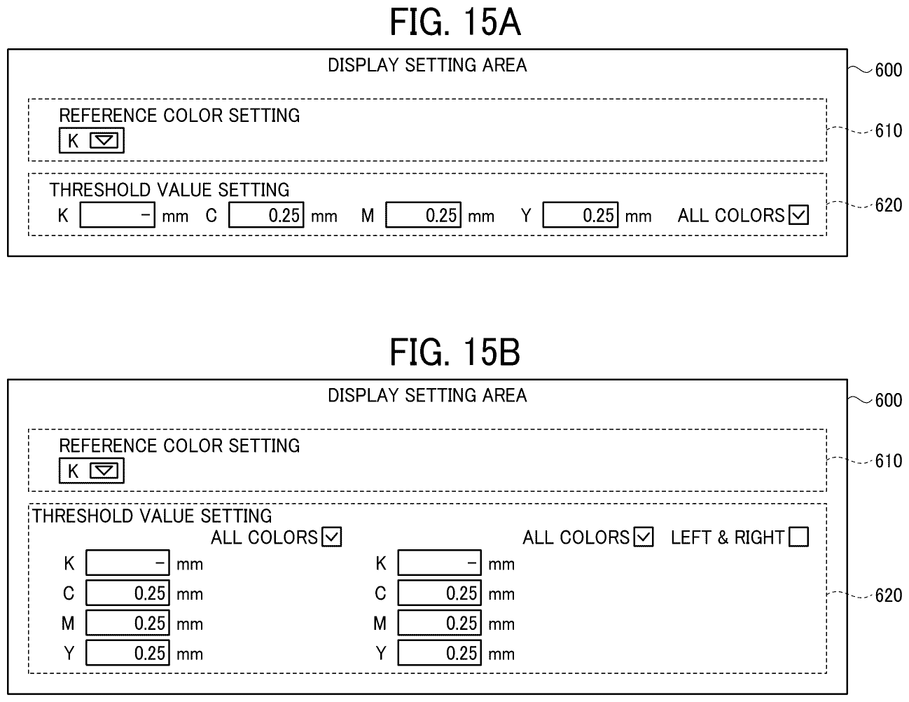

FIGS. 15A and 15B are diagrams each illustrating a screen in which the display setting area 600 is displayed, according to the first embodiment. The display setting area 600 includes a reference color setting area 610 and the threshold value setting area 620.

The reference color setting area 610 is used for the operator to input a reference color for calculating a difference to be included in positional deviation information. The positional deviation information calculation unit 2013 calculates the positional deviation information using the information on the difference. In FIGS. 15A and 15B, as the reference color, K color is set. In this case, the coordinates of the image of K color in FIG. 14 are used as a reference, and the difference between the coordinates of the image of K color and the coordinates of the image of each of C, M, and Y colors is calculated as positional deviation information. As the reference color, any one of C, M, and Y colors other than K color may be set.

The threshold value setting area 620 is used for the operator to input a threshold value for the image of each color. In FIG. 15A, a screen in which the same threshold value is set for the image of each color in the left and the right of the inspection chart is illustrated. In FIG. 15B, a screen in which different threshold values are allowed to be set for the image of each color on the left and the right of the inspection chart is illustrated. When a check box labeled “LEFT & RIGHT” in FIG. 15B is checked, as in FIG. 15A, the same threshold value is set for the image of each color in the left and the right of the inspection chart. When the values are set as illustrated in FIG. 15A or 15B, 0.25 mm is set to all the threshold values Ct, Mt, and Yt in FIG. 14. Since the positional deviation information for the reference color is not calculated, the threshold value corresponding to the reference color (K in FIGS. 15A and 15B) is displayed as “-” in the threshold value setting area 620.

In the embodiment described above, a case has been described in which the operator sets the values and the like of each area in the display setting area 600. However, some of these values and the like may be set in advance. For example, the values and the like set in advance may be K color for the reference color and 0.25 mm for the threshold values.

The display control unit 2002 controls the display of various information including the inspection result on the operation panel 117 or another device. Examples of the other device include a communication terminal such as a personal computer or a tablet terminal used by the operator and the DFE apparatus. In response to a request from software such as a web browser operating on the other device, the display control unit 2002 may transmit the information stored in, for example, the inspection apparatus 20 to the other device.

Alternatively, the display control unit 2002 and the software of the other device may use a bidirectional communication protocol such as WebSocket so that the display control unit 2002 transmits the information stored in the inspection apparatus 20 to the other device and the other device displays the information in real time. For example, assuming that the software of the other device accesses the inspection apparatus 20 to display a list of printed sheets having positional deviation, the list is automatically updated each time a printed sheet having positional deviation is detected, and information on the printed sheet having positional deviation or information on the sheet is additionally displayed.

The display control unit 2002 may be included in the inspection apparatus 20 as a web server, or may be included in a cloud server that receives the information on the inspection result from the inspection apparatus 20.

The network I/F control unit 2003 controls the network with external devices. The external I/F control unit 2004 controls an interface with external devices.

The storage unit 2005 stores various information. Specifically, the storage unit 2005 stores history information on job execution relating to a job for which processing has been completed, read image data, and information on the inspection result. The mechanism control unit 2006 controls the operation of the mechanism of the inspection apparatus 20. The reading unit 2007 acquires read image data (read data of the inspection chart printed on a sheet) from the reading device 131. The reading unit 2007 may have a function of reading an image.

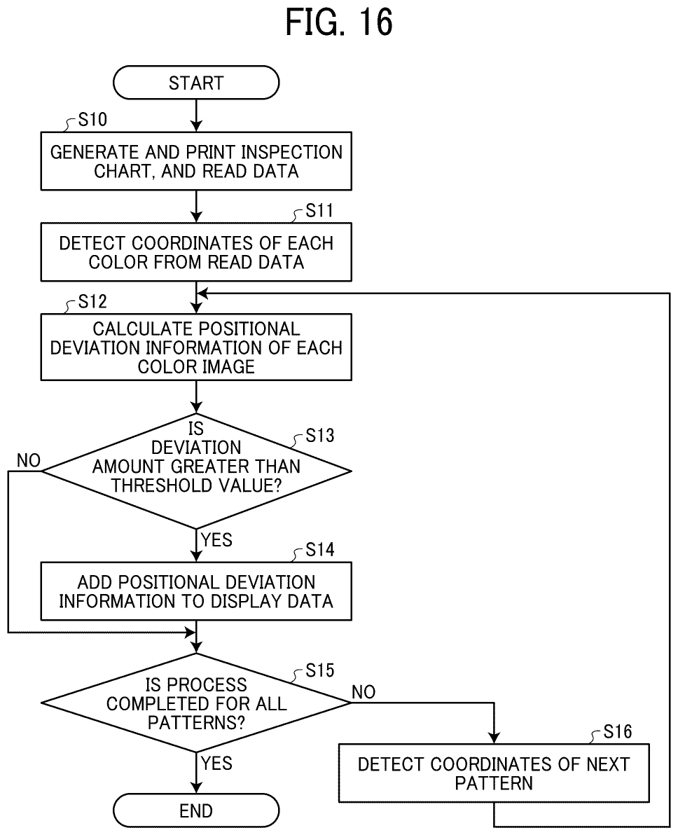

FIG. 16 is a flowchart of a positional deviation detection process according to the first embodiment. First, in step S10, the chart generation unit 1014 generates an inspection chart, the reading device 131 reads the inspection chart printed on a sheet to generate read image data, and the reading unit 2007 acquires the read image data (read data).

In step S11, the coordinate detection unit 2012 detects the coordinates of the image of each color from the read data for the pattern first from the top of the inspection chart. In step S12, the positional deviation information calculation unit 2013 calculates positional deviation information of the image of each color based on the coordinates detected by the coordinate detection unit 2012.

In step S13, the positional deviation determination unit 2015 compares the deviation amount obtained from the positional deviation information calculated by the positional deviation information calculation unit 2013 with the threshold value set by the threshold value setting unit 2014. In the present embodiment, the deviation amount is an absolute value of a difference of the image of each color (a difference between the coordinates of an image of a reference color and the coordinates of an image of each color other than the reference color) included in the positional deviation information.

In the case where the deviation amount of at least one image included in one pattern is determined to be greater than the threshold value (YES in step S13), the positional deviation determination unit 2015 adds positional deviation information to the display data indicating the inspection result in step S14. In the case where the deviation amounts of all the images included in one pattern are determined to be equal to or smaller than the respective threshold values (NO in step S13), the positional deviation information of the pattern is not added to the display data.

In step S15, the system control unit 2001 determines whether the process has been completed for all the patterns. In the case where the process is determined not to have been completed for all the patterns (NO in step S15), in step S16, the system control unit 2001 detects the coordinates of the next pattern from the read data and returns the process to step S12. The system control unit 2001 repeats the processes of steps S12 to S16, and ends the detection process when the process has been completed for all the patterns.

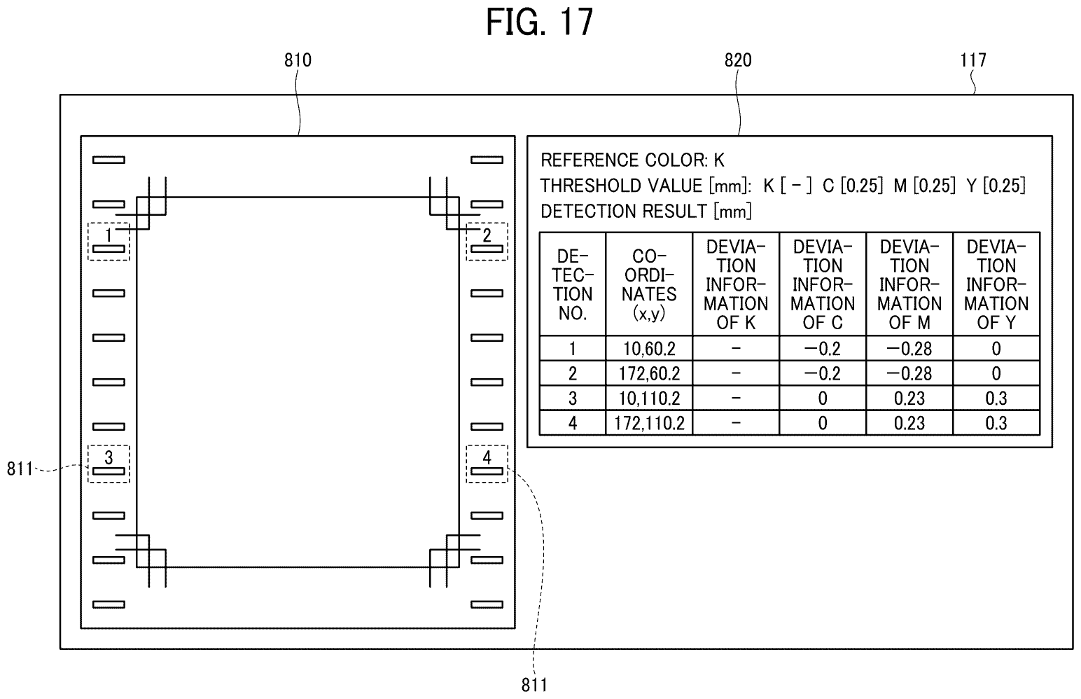

FIG. 17 is a diagram illustrating the detection result generated through the detection process according to the first embodiment. The detection result displayed on the operation panel 117 includes a read data area 810 and a detection result area 820. In the read data area 810, the left and the right of the inspection chart are displayed. The read data area 810 includes detected pattern areas 811 where the numbers (detection numbers) of the patterns having a positional deviation whose deviation amount is determined to be greater than the threshold value are displayed. In the read data area 810, the cutting marks and the user image may be displayed as illustrated in FIG. 17, or only the left and the right of the inspection chart and the detected pattern areas 811 may be displayed.

In the detection result area 820, the reference color used for the inspection, the threshold values, and a table of the detection result are displayed. In the table of the detection result, together with the detection number of a pattern, the coordinates of the upper left corner of the pattern, and the positional deviation information of the image of each color of the pattern are displayed by row. In this case, the calculated difference is displayed as the positional deviation information regardless of the threshold value. However, the difference exceeding the threshold value may be displayed in, for example, red so as to be noticeable.

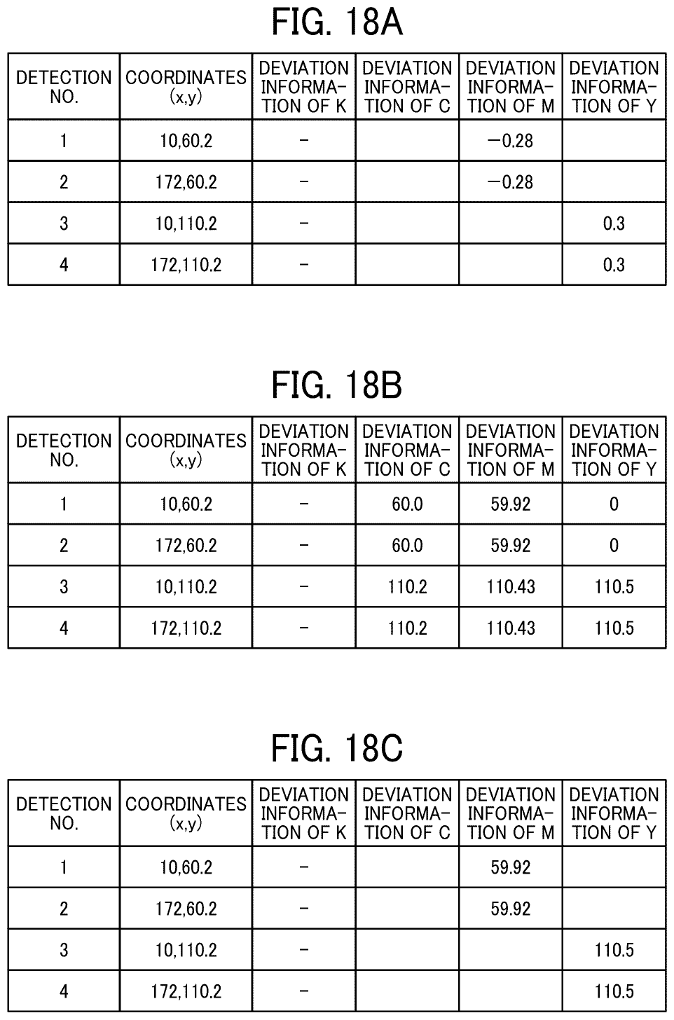

Only the difference exceeding the threshold value may be displayed as the positional deviation information, or the coordinate of the sub-scanning position may be used instead of the difference. FIGS. 18A to 18C are diagrams each illustrating the table of the detection result displayed in another manner according to the first embodiment. In FIG. 18A, a case in which only the difference exceeding the threshold value is displayed. Accordingly, only the information of the difference exceeding the threshold value of 0.25 mm is displayed. In each of FIGS. 18B and 18C, a case in which the coordinate in the sub-scanning direction is obtained as the positional deviation information instead of the difference is illustrated. In FIG. 18B, the positional deviation information is displayed regardless of the threshold value. In FIG. 18C, the coordinate is displayed as the positional deviation information only when the difference exceeds the threshold value.

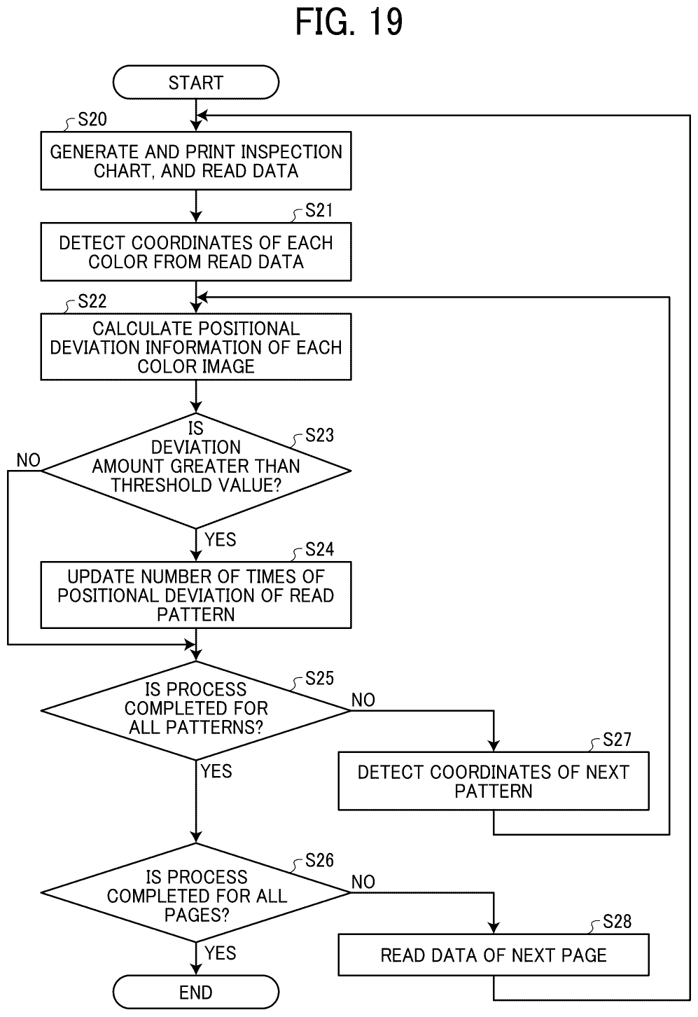

In the present embodiment, multiple pages of the inspection chart are printed and read, and a statistical value of the positional deviation information of each pattern can be obtained. FIG. 19 is a flowchart of the process to obtain a statistical value of positional deviation information through the detection process, according to the first embodiment. The difference from FIG. 16 is that the process of step S24 for updating the number of times of the positional deviation is used instead of the process of step S14, and the processes of steps S26 and S28 are added for processing the multiple pages. Since the rest of the processes is substantially the same as the processes of FIG. 16, the descriptions thereof are omitted.

In the case where the deviation amount of at least one image included in one pattern is determined to be greater than the threshold value (YES in step S23), in step S24, the positional deviation determination unit 2015 updates the number of times of positional deviation (the number of times of deviation) for the one image included in the pattern. The initial value of the number of times of deviation is set to zero (0) for each image included each pattern, and is updated so as to increase by one (1) each time a deviation amount greater than the threshold value is detected for each image.

When the process has been completed for one page, the system control unit 2001 determines whether the process has been completed for all the pages in step S26. In the case where the process is determined not to have been completed for all the pages (NO in step S26), in step S28, the system control unit 2001 reads the data of the next page and returns the process to step S20. The system control unit 2001 repeats the processes of steps S20 to S28, and ends the detection process when the process has been completed for all the pages.

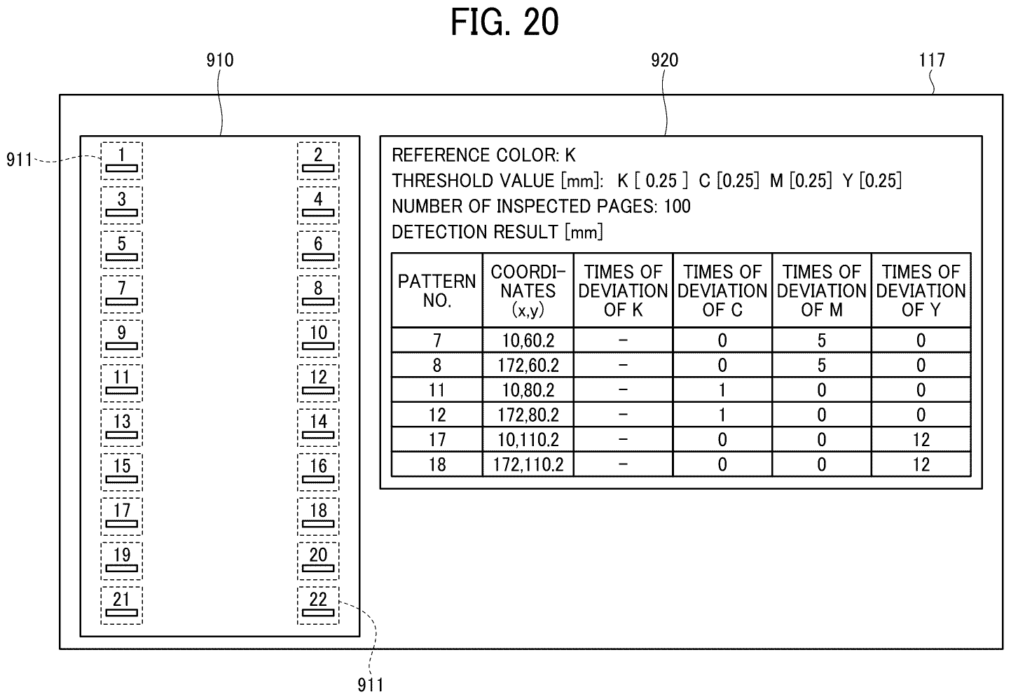

FIG. 20 is a diagram illustrating the statistical value of the positional deviation information of each pattern generated through the detection process, according to the first embodiment. The detection result displayed on the operation panel 117 includes a read data area 910 and a detection result area 920. In the read data area 910, the left and the right of the inspection chart are displayed. The read data area 910 includes pattern areas 911 where the number of each pattern (the pattern number) is displayed. In the read data area 910, the cutting marks and the user image may be displayed additionally.

In the detection result area 920, the reference color used for the inspection, the threshold values, the number of pages inspected, and a table of the detection result are displayed. In the table of the detection result, together with the pattern number of a pattern, the coordinates of the upper left corner of the pattern, and the number of times of deviation of the image of each color included in the pattern are displayed by row. The operator may be allowed to switch between the display of the number of times of deviation as illustrated in FIG. 20 and the display of the positional deviation information of a specific page as illustrated in FIG. 17. In this case, the page number of the page of the inspection chart is displayed in the detection result area 820 of FIG. 17. Further, an upper limit for the number of times of deviation may be set in advance. In the case where the number of times of deviation exceeds the upper limit, the system control unit 2001 may notify the operator that maintenance is required for the color of the image for which the number of times of deviation exceeds the upper limit. If the image forming apparatus 1 includes a mechanism for automatically performing maintenance, the maintenance of the color of the image for which the number of times of deviation exceeds the upper limit may be automatically performed. For example, when the positional deviation of the image of M color of the detection number 1 in FIG. 17 is maintained, the printing position of the image of M color is adjusted to be in the positive direction by 0.28 mm. In the case where the positions of the images of the colors other than the reference color are deviated in the same direction relative to the image of the reference color, the printing positions of the images of the other colors may be adjusted in the direction opposite to the deviation, or only the printing position of the image of the reference color may be adjusted in the direction of the deviation.

The technique in the art has an issue that color shift caused by a local variation in the sub-scanning direction cannot be detected.

As described above, according to the present embodiment, the positional deviation information can be detected using a pattern repeatedly arranged in the sub-scanning direction, in which the image of the reference color and the images of the colors other than the reference color are arranged in the main scanning direction. Thus, color shift caused by a local variation in the sub-scanning direction can be detected. Further, since the reference color, the size and position of each image included in the pattern, the interval between the patterns can be set using the chart setting screen, a desired inspection chart can be used according to the type of a sheet. Furthermore, the border area can be set for the pattern. Thus, even when the pattern is superimposed on the user image, the coordinates of the image of each color included in the pattern can be easily detected.

### Second Embodiment

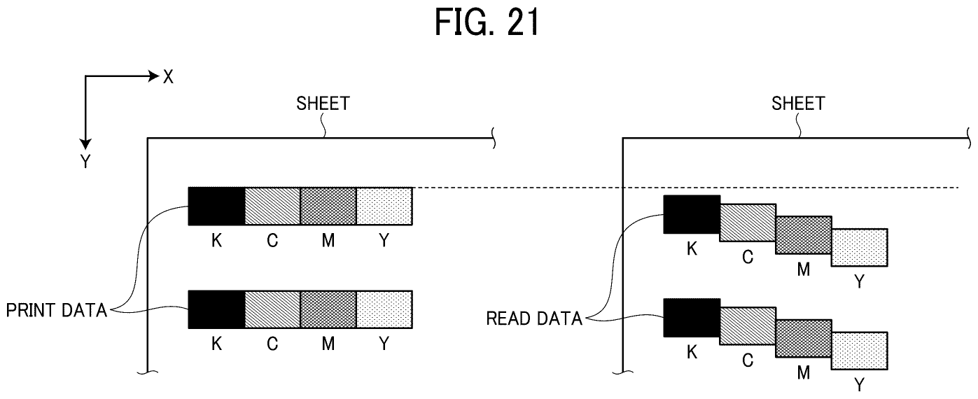

FIG. 21 is a diagram illustrating the pattern of the inspection chart in the print data and the read data, according to the first embodiment. In FIG. 21, the pattern of the inspection chart in the print data is illustrated on the left and the pattern of the inspection chart in the read data is illustrated on the right. As illustrated in FIG. 21, the images of the colors in the read data are positionally deviated in the sub-scanning direction compared to those in the print data due to the positional deviations of the colors at the time of printing. In the present embodiment, the positional deviation of the image of each color is detected by comparing the coordinates of the sub-scanning position of the image of each color in the read data with the coordinates of the sub-scanning position of the image of each color in the print data.

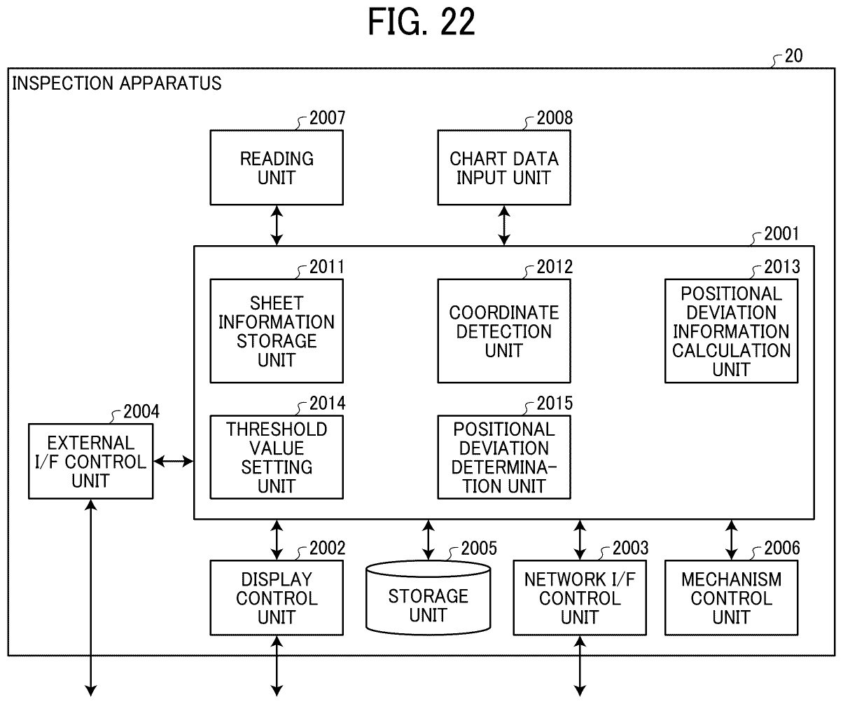

FIG. 22 is a block diagram illustrating a functional configuration of the inspection apparatus 20 according to a second embodiment. The difference from the first embodiment is that the inspection apparatus 20 includes a chart data input unit 2008, and the system control unit 2001 calculates positional deviation information and determines positional deviation using the coordinates of the image of each color in the print data and the coordinates of the image of each color in the read data input from the reading unit 2007, and generates display data. Since the rest of the operations is substantially the same as the operations of the first embodiment, the descriptions thereof are omitted.

The chart data input unit 2008 inputs data for setting the inspection chart. The coordinate detection unit 2012 calculates the coordinates of the pattern in the print data based on the input data for setting the inspection chart, and detects the coordinates of the upper end of the image of each color from the read data using, for example, pattern matching.

The positional deviation information calculation unit 2013 calculates positional deviation information for the image of each color based on the coordinates detected by the coordinate detection unit 2012. The threshold value setting unit 2014 sets a threshold value used for determining the deviation amount for the image of each color.

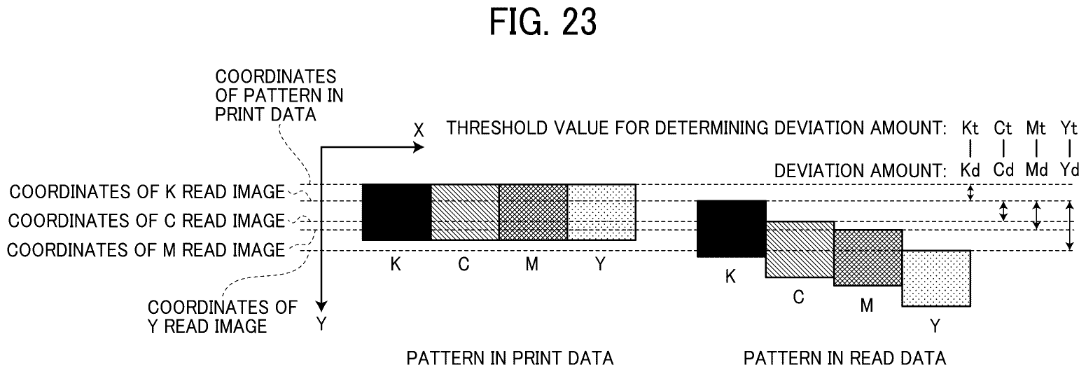

Since the positional deviation information according to the present embodiment is information indicating the deviation amount according to the print data as a reference, a reference color is not set, and the positional deviation information is calculated for the images of all the colors. FIG. 23 is a diagram illustrating the coordinates of the pattern in the print data and the coordinates of the image of each color in the read data, according to the second embodiment. As illustrated in FIG. 23, when the images of K, C, M, and Y colors are printed with deviations in the sub-scanning direction relative to the pattern in the print data due to positional deviation at the time of printing, the deviation amounts of the images of K, C, M, and Y colors are Kd, Cd, Md, and Yd, respectively, based on the coordinates of the images of the respective colors in the read data. As the threshold values for determining the positional deviation for the deviation amounts of Kd, Cd, Md, and Yd, Kt, Ct, Mt, and Yt are set, respectively.

The positional deviation determination unit 2015 determines the positional deviation based on the positional deviation information and the threshold value, and outputs the determination result to the display control unit 2002.

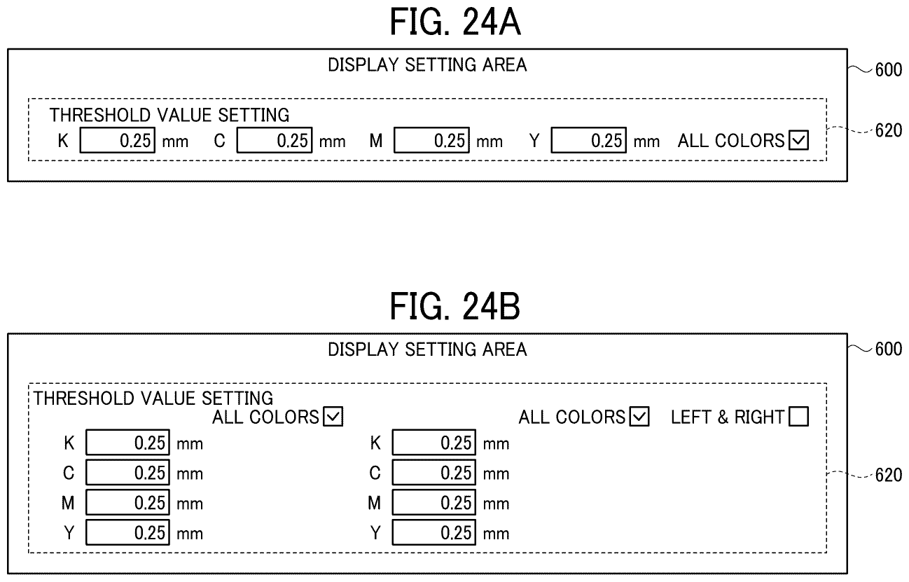

FIGS. 24A and 24B are diagrams each illustrating the display setting area 600 according to the second embodiment. As described above, since a reference color is not set, the display setting area 600 includes only the threshold value setting area 620. The rest of the configuration is substantially the same as the configuration described with reference to FIG. 15.

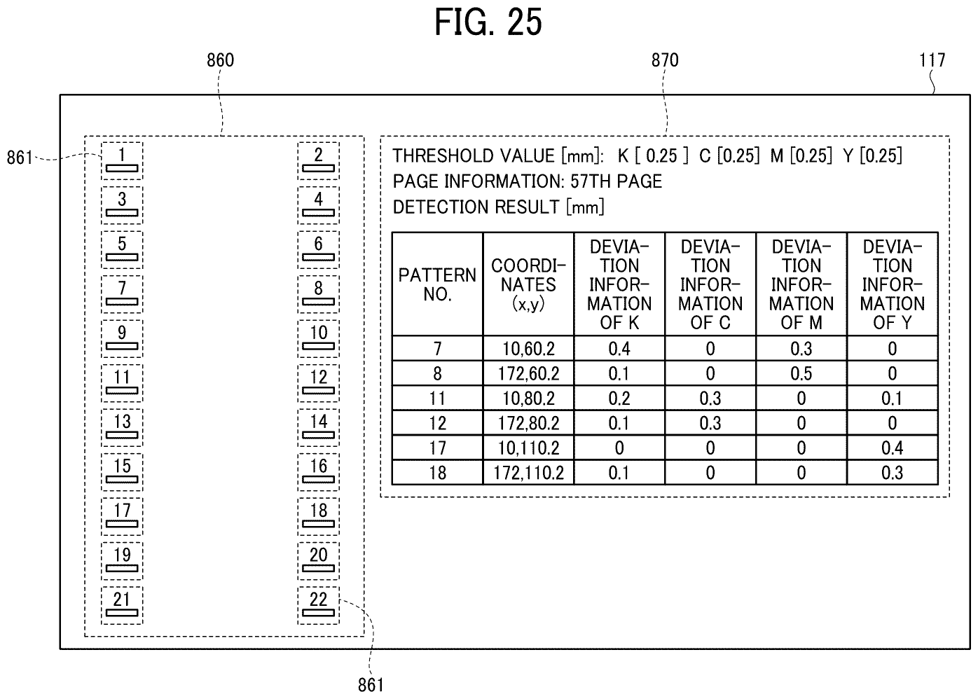

FIG. 25 is a diagram illustrating the detection result generated through the detection process according to the second embodiment. The detection result displayed on the operation panel 117 includes a read data area 860 and a detection result area 870. In the read data area 860, the left and the right of the inspection chart are displayed. The read data area 860 includes pattern areas 861 where each pattern number is displayed. Similarly to the read data area 810 in FIG. 17, in the read data area 860, the cutting marks and the user image may be displayed, or only the numbers (detection numbers) of the patterns having a positional deviation whose deviation amount is determined to be greater than the threshold value may be displayed.

In the detection result area 870, the threshold values. page information, and a table of the detection result are displayed. For example, when multiple pages of the inspection chart are printed and read to obtain a statistical value of the positional deviation information for each pattern, the page information indicates the page number out of the multiple pages of the inspection chart to which the inspection result corresponds. In the table of the detection result, together with the pattern number of a pattern, the coordinates of the upper left corner of the pattern in the print data, and the positional deviation information of the image of each color included in the pattern in the read data are displayed by row. In this case, the calculated difference is displayed as the positional deviation information regardless of the threshold value. However, the difference exceeding the threshold value may be displayed in, for example, red so as to be noticeable.

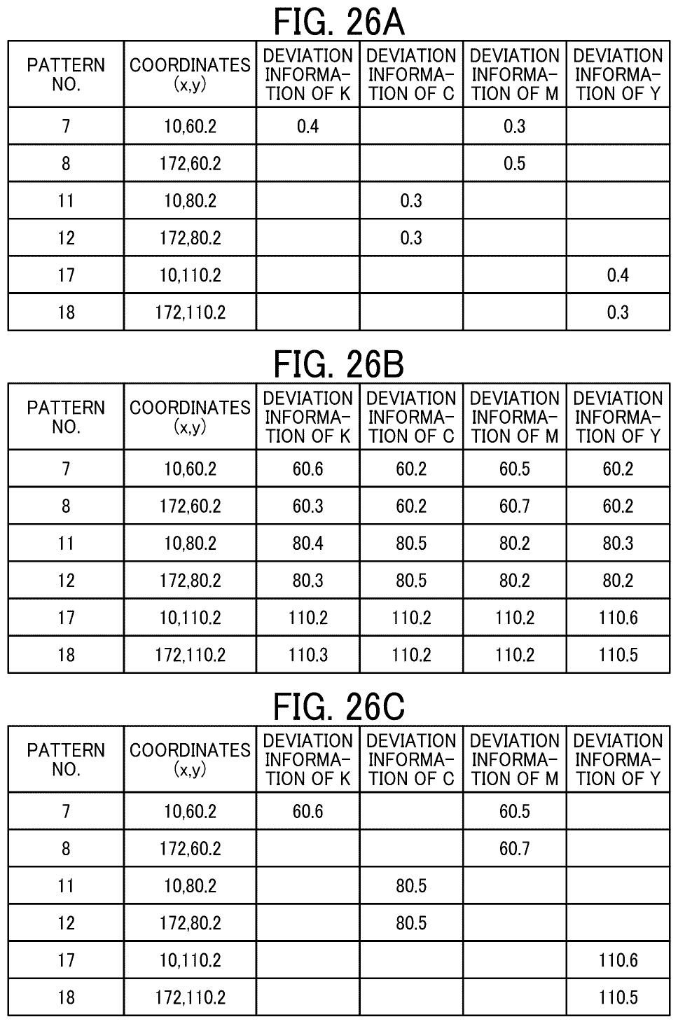

As in the first embodiment, only the difference exceeding the threshold value may be displayed as the positional deviation information, or the coordinate of the sub-scanning position of the image of each color in the read data may be used instead of the difference. FIGS. 26A to 26C are diagrams each illustrating the table of the detection result displayed in another manner, according to the second embodiment. In FIG. 26A, a case in which only the difference exceeding the threshold value is displayed. Accordingly, only the information of the difference exceeding the threshold value of 0.25 mm is displayed. In each of FIGS. 26B and 26C, a case in which the coordinate in the sub-scanning direction in the read data is obtained as the positional deviation information instead of the difference is illustrated. In FIG. 26B, the positional deviation information is displayed regardless of the threshold value. In FIG. 26C, the coordinate is displayed as the positional deviation information only when the difference exceeds the threshold value.

As described above, according to the present embodiment, the positional deviation information can be detected using the coordinates of the pattern in the print data and the coordinates of the image of each color included in the pattern in the read data. Thus, color shift caused by a local variation in the sub-scanning direction can be detected. Since the coordinates of the pattern in the print data are used as a reference, the positional deviation information can be detected for the images of all the colors in the read data.

Although the embodiments of the present disclosure have been described above, the above-described embodiments are presented as examples and are not intended to limit the scope of the present disclosure. For example, instead of the printer 10, the inspection apparatus 20 may have the functions of the chart generation unit 1014. Such novel embodiments may be carried out in various other modified forms. Various omissions, substitutions, and changes may be made without departing from the gist of the present disclosure. Such novel embodiments and modifications thereof are within the scope and gist of the present disclosure and are also within the scope of the claims and the equivalent thereof. The elements of different embodiments or modifications may be combined with each other as appropriate.

Each of the functions of the embodiments described above may be implemented by one or more processing circuits or circuitry. The “processing circuit or circuitry” herein includes a programmed processor to execute each function by software, such as a processor implemented by an electronic circuit, and devices, such as an application-specific integrated circuit (ASIC), a digital signal processor (DSP), a field-programmable gate array (FPGA), and circuit modules known in the art arranged to perform the recited functions.

Aspects of the present disclosure are, for example, as follows.

According to Aspect 1, an image forming apparatus superimposes a plurality of images one on another on a medium to form a color image. The image forming apparatus includes an image arranging unit, a reading unit, and a detection unit. The image arranging unit arranges, in image forming data, a pattern that includes a first image formed of an image having a first color and a second image formed of another image having a second color different from the first color. The reading unit reads the color image formed on the medium using the image forming data. The detection unit detects positional deviation information on at least one of the image having the first color and the other image having the second color based on the color image read by the reading unit. Further, the image arranging unit arranges the first image at a position that simultaneously satisfies both a first main scanning position and a first sub-scanning position, and arranges the second image at a position that simultaneously satisfies both a second main scanning position different from the first main scanning position and the first sub-scanning position.

According to Aspect 2, the image forming apparatus of Aspect 1, further includes a position setting unit that sets a position of at least one of the first image and the second image arranged by the image arranging unit. The position setting unit sets the first sub-scanning position and sets an interval at which the pattern is repeatedly arranged in the sub-scanning direction.

According to Aspect 3, the image forming apparatus of Aspect 1 or 2, includes the position setting unit that sets a position of at least one of the first image and the second image arranged by the image arranging unit. The position setting unit sets the first main scanning position.

According to Aspect 4, the image forming apparatus of any one of Aspects 1 to 3, further includes a size setting unit that sets the size of at least one of the first image and the second image arranged by the image arranging unit. The size setting unit sets the height and width of the first image and the height and width of the second image.

According to Aspect 5, the image forming apparatus of any one of Aspects 1 to 4, further includes a border area setting unit that sets information on a border area formed of a color different from the first color and the second color. The border area setting unit sets a size and a color of the border area. The image arrangement unit arranges, in the image forming data, the first image and the second image having the border area whose size and color set by the border area setting unit.

According to Aspect 6, the image forming apparatus of any one of Aspects 1 to 5, further includes a cutting area setting unit that sets information on a cutting area of the medium. The cutting area setting unit sets a position of the cutting area. The image arranging unit arranges the first image and the second image inside the cutting area based on the position of the cutting area.

According to Aspect 7, in the image forming apparatus of any one of Aspects 1 to 6, the detection unit detects the coordinates of the sub-scanning position of the first image read by the reading unit and the coordinates of the sub-scanning position of the second image read by the reading unit. Further, the detection unit detects, as the positional deviation information on the second image, the coordinates of the sub-scanning position of the second image, a first difference between the sub-scanning position of the first image and the sub-scanning position of the second image, or a second difference between the sub-scanning position of the first image arranged by the image arranging unit and the sub-scanning position of the second image read by the reading unit.

According to Aspect 8, the image forming apparatus of any one of Aspects 1 to 7, further includes a display unit that displays the positional deviation information.

According to Aspect 9, the image forming apparatus of any one of Aspects 1 to 7, further includes a display unit that displays the positional deviation information. The display unit displays the positional deviation information in the case where an absolute value of one of the first difference and the second difference exceeds a threshold value.

According to Aspect 10, the image forming apparatus of Aspect 9, further includes a threshold value setting unit that sets the threshold value.

According to Aspect 11, the image forming apparatus of Aspect 9 or 10 performs a detection process to detect the positional deviation information a plurality of times. The display unit displays the number of times of the detection process in which the absolute value of one of the first difference and the second difference exceeds the threshold value for the second image.

According to Aspect 12, an image forming method for superimposing a plurality of images one on another on a medium to form a color image, includes arranging, in image forming data, a pattern that includes a first image formed of an image having a first color and a second image formed of another image having a second color different from the first color, reading the color image formed on the medium using the image forming data with a reading device, detecting positional deviation information on at least one of the image having the first color and the other image having the second color based on the color image read by the reading device, arranging the first image at a position that simultaneously satisfies both a first main scanning position and a first sub-scanning position, and arranging the second image at a position that simultaneously satisfies both a second main scanning position different from the first main scanning position and the first sub-scanning position.

According to Aspect 13, a non-transitory recording medium stores a plurality of program codes which, when executed by one or more processors, causes an image forming apparatus for superimposing a plurality of images one on another on a medium to form a color image to perform a method including arranging, in image forming data, a pattern that includes a first image formed of an image having a first color and a second image formed of another image having a second color different from the first color, reading the color image formed on the medium using the image forming data with a reading device, detecting positional deviation information on at least one of the image having the first color and the other image having the second color based on the color image read by the reading device, arranging the first image at a position that simultaneously satisfies both a first main scanning position and a first sub-scanning position, and arranging the second image at a position that simultaneously satisfies both a second main scanning position different from the first main scanning position and the first sub-scanning position.

Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
circuitry configured to generate image forming data in which a pattern that includes a first image formed with a first color and a second image formed with a second color different from the first color is arranged,
the first image being arranged at a position that simultaneously satisfies a first main scanning position and a first sub-scanning position, and
the second image being arranged at a position that simultaneously satisfies a second main scanning position and the first sub-scanning position, the second main scanning position being different from the first main scanning position;
a print engine to form a color image on a medium based on the image forming data, the color image having a plurality of images superimposed one above the other; and
a reading device to read the color image formed on the medium,
wherein the circuitry is further configured to detect positional deviation information indicating a deviation of at least one of the first image or the second image based on the color image read by the reading device.

2. The image forming apparatus according to claim 1, wherein the circuitry is configured to:
set the first sub-scanning position and an interval between the pattern and a subsequent pattern to be subsequently arranged in a sub-scanning direction; and
set positions of the first image and the second image based on the first sub-scanning position and the interval.

3. The image forming apparatus according to claim 1, wherein the circuitry is further configured to:
set the first main scanning position; and
set positions of the first image and the second image based on the first main scanning position.

4. The image forming apparatus according to claim 1, wherein the circuitry is further configured to:
set a height and a width of the first image and a height and a width of the second image, such that sizes of the first image and the second image are set.

5. The image forming apparatus according to claim 1, wherein the circuitry is further configured to:
set a size and a color of a border area, the color of the border area being different from the first color and the second color; and
arrange the first image and the second image each including the border area having the set size and color.

6. The image forming apparatus according to claim 1, wherein the circuitry is further configured to:
set a position of a cutting area; and
arrange the first image and the second image inside the cutting area based on the position of the cutting area.

7. The image forming apparatus according to claim 1, wherein the circuitry is configured to:
detect coordinates of a sub-scanning position of the first image read by the reading device;
detect coordinates of another sub-scanning position of the second image read by the reading device; and
detect, as the positional deviation information on the second image, one of the coordinates of the another sub-scanning position of the second image,
a first difference between the sub-scanning position of the first image and the another sub-scanning position of the second image, and
a second difference between the arranged sub-scanning position of the first image and the another sub-scanning position of the second image read by the reading device.

8. The image forming apparatus according to claim 1, wherein the circuitry is further configured to display the positional deviation information on a display.

9. The image forming apparatus according to claim 7, the circuitry is further configured to:
display the positional deviation information on a display in a case that an absolute value of one of the first difference and the second difference exceeds a threshold.

10. The image forming apparatus according to claim 9, wherein the circuitry is configured to set the threshold.

11. The image forming apparatus according to claim 9, wherein the circuitry is further configured to:
perform a detection process to detect the positional deviation information a plurality of times; and
display a number of times of the detection process in which the absolute value of one of the first difference and the second difference exceeds the threshold for the second image.

12. An image forming method comprising:
generating image forming data in which a pattern that includes a first image formed with a first color and a second image formed with a second color different from the first color is arranged,
the first image being arranged at a position that simultaneously satisfies a first main scanning position and a first sub-scanning position, and
the second image being arranged at a position that simultaneously satisfies a second main scanning position and the first sub-scanning position, the second main scanning position being different from the first main scanning position;
forming a color image on a medium based on the image forming data, the color image having a plurality of images superimposed one above the other;
reading the color image formed on the medium with a reading device;
detecting positional deviation information indicating a deviation of at least one of the image or the another image based on the color image read by the reading device.

13. A non-transitory recording medium storing a plurality of program codes which, when executed by one or more processors, causes the one or more processors to perform a method, the method comprising:
generating image forming data in which a pattern that includes a first image formed with a first color and a second image formed with a second color different from the first color is arranged,
the first image being arranged at a position that simultaneously satisfies a first main scanning position and a first sub-scanning position, and
the second image being arranged at a position that simultaneously satisfies a second main scanning position and the first sub-scanning position, the second main scanning position being different from the first main scanning position;
forming a color image on a medium based on the image forming data, the color image having a plurality of images superimposed one above the other;
reading the color image formed on the medium with a reading device;
detecting positional deviation information indicating a deviation of at least one of the image or the another image based on the color image read by the reading device.
